(19) United States
(12) Patent Application Publication
(10) Pub. No.: US 2016/0180778 A1
(43) Pub. Date: Jun. 23, 2016

(54) LIGHT GENERATING DEVICE AND DISPLAY APPARATUS HAVING THE SAME

(71) Applicant: Samsung Display Co., Ltd., Yongin-si (KR)

(72) Inventors: Moon-hwan CHANG, Yongin-si (KR); Seokhyun NAM, Seoul (KR)

(21) Appl. No.: 14/825,562

(22) Filed: Aug. 13, 2015

(30) Foreign Application Priority Data
Dec. 22, 2014 (KR) 10-2014-0186163

(51) Int. Cl. G09G 3/34; G09G 3/20; H05B 33/08

(52) U.S. Cl. CPC G09G 3/3406; H05B 33/0848; G09G 3/2003; G09G 2320/0666; G09G 2330/028; G09G 2360/04; G09G 2330/021; G09G 2320/0626

(57) ABSTRACT

A display apparatus includes a light source driving part generating a driving voltage in response to a control signal, a light source part generating a light in response to the driving voltage, a display panel receiving the light to display an image, a measuring part receiving the light from the light source part to measure a spectral power distribution of the light, an extracting part measuring optical data by elements of the light source part on the basis of the spectral power distribution and extracting optical characteristics by the elements on the basis of the optical data, and a light source controlling part controlling the control signal on the basis of the optical characteristics.

### CLAIM OF PRIORITY

This U.S. non-provisional patent application claims the priority of and all the benefits accruing under 35 U.S.C. §119 of Korean Patent Application No. 10-2014-0186163, filed on Dec. 22, 2014 in the Korean Intellectual Property Office (KIPO), the contents of which are hereby incorporated by reference in its entirety.

### BACKGROUND OF THE INVENTION

1. Field of Disclosure

The present disclosure relates to a light generating device and a display apparatus having the same. More particularly, the present disclosure relates to a light generating device capable of extracting optical characteristics (e.g. color coordinate, correlated color temperature, etc.) of a light source part and a display apparatus having the light generating device.

2. Description of the Related Art

In general, a liquid crystal display device includes a liquid crystal display panel displaying an image using a light transmittance of liquid crystals and a backlight assembly disposed under the liquid crystal display device to provide a light to the liquid crystal display device.

The backlight assembly includes a light source generating the light required to display the image on the liquid crystal display panel, and in recent years, a light emitting diode having low power consumption and high color reproducibility is used as the light source. The light emitting diode includes red, green, and blue light emitting diodes. Red, green, and blue lights respectively emitted from the red, green, and blue light emitting diodes are mixed with each other to generate a white light.

However, the light emitting diodes have a disadvantage in which brightness of the light emitting diodes is changed depending on hours of use. Accordingly, the backlight assembly employing the light emitting diodes as its light source compensates for the change in brightness of the light emitting diodes to improve the color reproducibility.

The backlight assembly detects an amount of the light emitted from each of the red, green, and blue light emitting diodes using color sensors. Then, the detected light amount is compared to a target white color coordinate and a target brightness value, and then driving signals applied to the red, green, and blue light emitting diodes are controlled with reference to a look-up table (LUT) in which compensation values are stored in response to the compared result, thereby controlling the brightness of the color.

However, since the compensation values are set without considering the change in optical characteristics (e.g., color coordinate, correlated color temperature, etc.) of the light emitting diodes during hours of use of the light emitting diodes, the target white color coordinate and the target value are not satisfied even though the driving signals are compensated on the basis of the compensation values.

### SUMMARY OF THE INVENTION

The present disclosure provides a light generating device capable of sensing optical characteristics of light emitting diodes in real-time to maintain a target color coordinate and a target brightness value.

The present disclosure provides a display apparatus displaying an image using the light generating device.

Embodiments of the inventive concept provide a light generating device including a light source driving part generating a driving voltage in response to a control signal, a light source part generating a light in response to the driving voltage, a measuring part receiving the light from the light source part to measure a spectral power distribution of the light, an extracting part measuring optical data by elements of the light source part on the basis of the spectral power distribution and extracting optical characteristics by the elements on the basis of the optical data, and a light source controlling part controlling the control signal on the basis of the optical characteristics.

Embodiments of the inventive concept provide a display apparatus includes a light source driving part generating a driving voltage in response to a control signal, a light source part generating a light in response to the driving voltage, a display panel receiving the light to display an image, a measuring part receiving the light from the light source part to measure a spectral power distribution of the light, an extracting part measuring optical data by elements of the light source part on the basis of the spectral power distribution and extracting optical characteristics by the elements on the basis of the optical data, and a light source controlling part controlling the control signal on the basis of the optical characteristics.

According to the above, the light generating device may maintain desired target optical characteristics, e.g., target color coordinate, target correlated color temperature, etc., even though the optical characteristics of the light source are changed according to hours of use, and thus the optical characteristics of the light emitted from the light generating device may be prevented from being degraded.

In addition, the display apparatus may prevent a display quality of the image displayed through the display apparatus from being degraded due to the change of the optical characteristics (e.g., color coordinate, correlated color temperature, etc.) of the light source part from the original optical characteristics according to the hours of use.

Further, although there are various types of structure of the light source part applied to the display apparatus and there are various types of elements used in the light source part, the various optical characteristics (i.e. color coordinate, correlated color temperature, etc.) provided by the various types of elements included in the various types of light source parts may be extracted by using the spectrophotometer. Accordingly, the light source part is driven in accordance with the original optical characteristics of the elements, and thus the light emitted from the light source part may be precisely controlled to have the target optical characteristics.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a block diagram showing a light generating device according to an exemplary embodiment of the present disclosure;

FIG. 2 is a plan view showing a light source part shown in FIG. 1;

FIG. 3 is a plan view showing a light emitting diode unit shown in FIG. 2;

FIG. 4 is a cross-sectional view showing a light emitting diode unit according to another exemplary embodiment of the present disclosure;

FIG. 5 is a graph showing a spectral power distribution of the light emitting diode unit shown in FIG. 4;

FIG. 6A is a waveform diagram showing a variation of a light flux as a function of a time of a light emitting diode unit;

FIG. 6B is a waveform diagram showing a variation of a peak area of a first spectral power distribution of a light emitting diode chip as a function of a time;

FIG. 6C is a waveform diagram showing a variation of a peak area of a second spectral power distribution of a fluorescent layer as a function of a time;

FIG. 7A is a waveform diagram showing a u′ chromaticity of a light emitting diode unit as a function of a time;

FIG. 7B is a waveform diagram showing a skew of a first spectral power distribution of a light emitting diode chip as a function of a time;

FIG. 7C is a waveform diagram showing a kurtosis of a first spectral power distribution of a light emitting diode chip as a function of a time;

FIG. 8A is a waveform diagram showing a v′ chromaticity of a light emitting diode unit as a function of a time;

FIG. 8B is a waveform diagram showing a skew of a second spectral power distribution of a fluorescent layer as a function of a time;

FIG. 8C is a waveform diagram showing a kurtosis of a second spectral power distribution of a fluorescent layer as a function of a time;

FIG. 9A is a waveform diagram showing a correlated color temperature (CCT) of a light emitting diode unit as a function of a time;

FIG. 9B is a waveform diagram showing a color rendering index (CRI) of a light emitting diode unit as a function of a time;

FIG. 9C is a waveform diagram showing a full-width-half-maximum (FWHM) of a first spectral power distribution of a light emitting diode unit as a function of a time;

FIG. 9D is a waveform diagram showing a full-width-half-maximum (FWHM) of a second spectral power distribution of a fluorescent layer as a function of a time;

FIG. 10 is a block diagram showing a display apparatus according to an exemplary embodiment of the present disclosure; and

FIG. 11 is a plan view showing a light source part shown in FIG. 10.

### DETAILED DESCRIPTION OF THE INVENTION

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

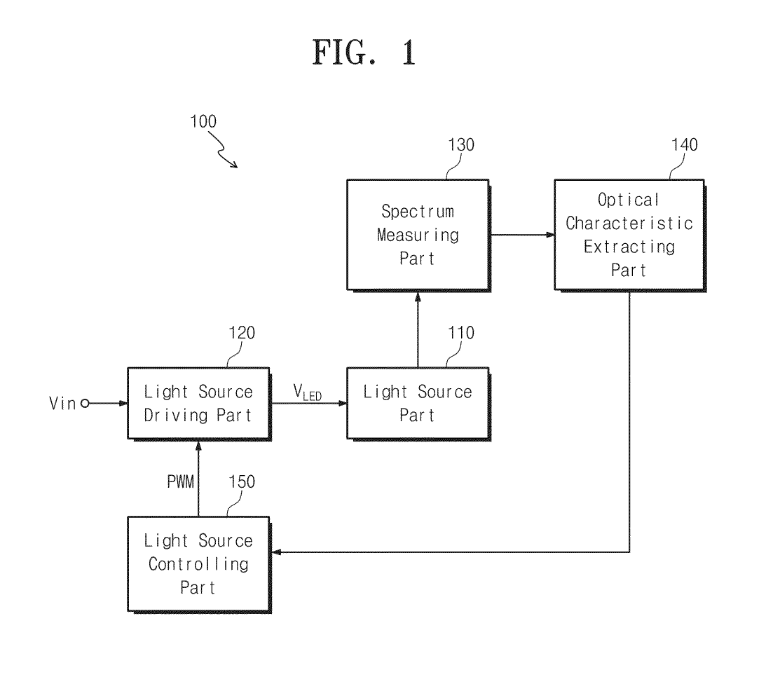

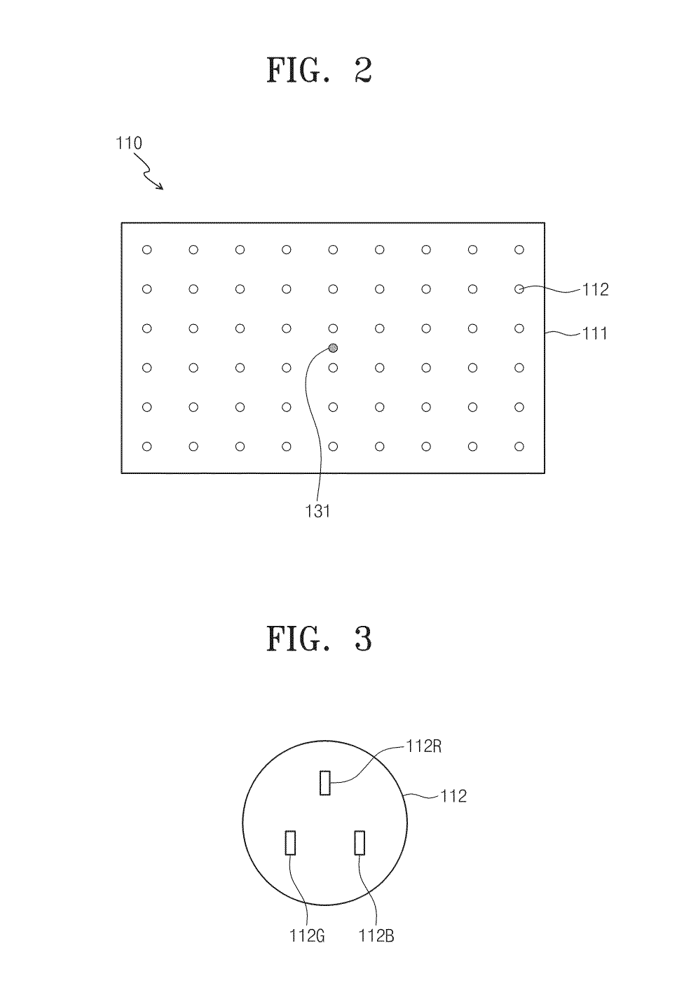

FIG. 1 is a block diagram showing a light generating device 100 according to an exemplary embodiment of the present disclosure, FIG. 2 is a plan view showing a light source part shown in FIG. 1, and FIG. 3 is a plan view showing a light emitting diode unit shown in FIG. 2.

Referring to FIG. 1, the light generating device 100 includes a light source part 110 receiving a voltage of V_{LED} to generate a light, a light source driving part 120 applying V_{LED} to drive the light source part 110 on the basis of a control signal PWM, a spectrum measuring part 130 measuring a spectral power distribution (SPD) of the light generated by the light source part 110, an optical characteristic extracting part 140 extracting optical characteristics of the light source part 110 on the basis of the spectral power distribution measured by the spectrum measuring part 130, and a light source controlling part 150 controlling the control signal PWM on the basis of the above extracted optical characteristics by the optical characteristic extracting part 140.

As shown in FIG. 2, the light source part 110 includes a plurality of light emitting diode units 112. The light emitting diode units 112 are arranged on a circuit substrate 111. As an example, the light emitting diode units 112 are arranged on the circuit substrate 111 in a matrix form, but this structure is employed to a direct-illumination type backlight unit. When the display apparatus employs an edge-illumination type backlight unit, the light emitting diode units 112 of the light source part 110 are sequentially arranged in one direction.

As shown in FIG. 3, each of the light emitting diode units 112 emits a white light. To emit the white light, each of the light emitting diode units 112 includes a red light emitting diode chip 112R emitting a red light, a green light emitting diode chip 112G emitting a green light, and a blue light emitting diode chip 112B emitting a blue light. The size and the number of the red, green, and blue light emitting diode chips 112R, 112G, and 112B included in each light emitting diode unit 112 are determined depending on a light emitting efficiency of each light emitting diode chip, and the light emitting diode units 112 have the same size and number or different sizes and numbers.

In addition, the red, green, and blue light emitting diode chips 112R, 112G, and 112B may be independently operated. Accordingly, the light source driving part 120 controls an intensity of a driving current applied to the red, green, and blue light emitting diode chips 112R, 112G, and 112B according to the light emission efficiency of each light emitting diode.

The configuration of each light emitting diode unit 112 should not be limited to the above-mentioned structure.

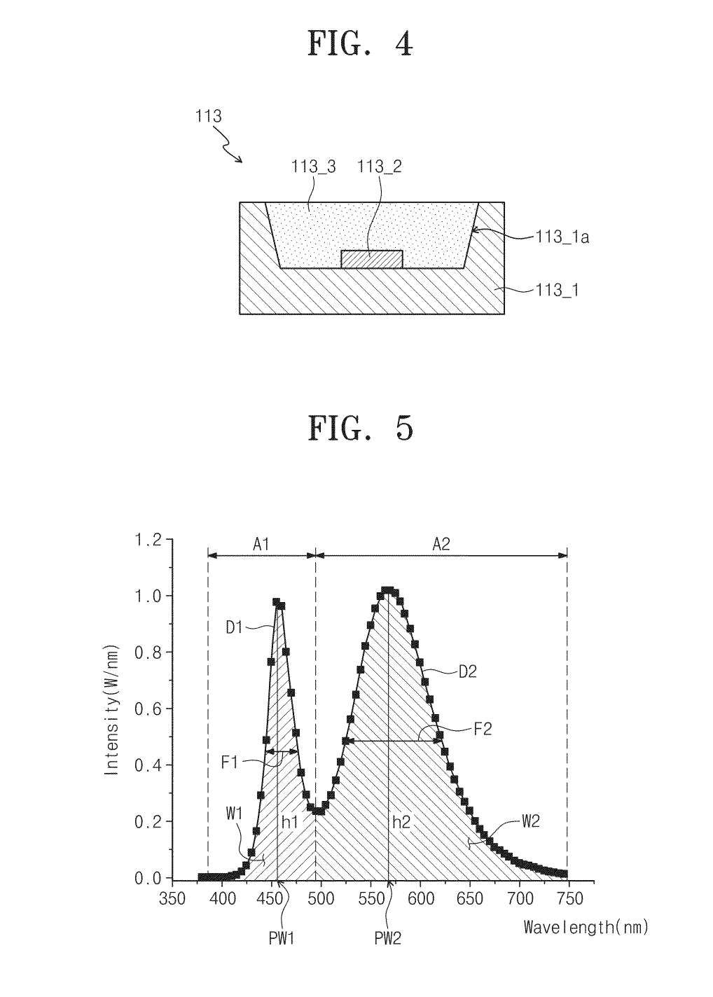

FIG. 4 is a cross-sectional view showing a light emitting diode unit 113 according to another exemplary embodiment of the present disclosure.

Referring to FIG. 4, the light emitting diode unit 113 includes a frame 113_1 in which an accommodating part 113_1a is formed, a light emitting diode chip 113_2 accommodated in the accommodating part 113_1a and emitting a blue light, and a fluorescent layer 113_3 disposed on the light emitting diode chip 113_2. The fluorescent layer 113_3 receives the emitting blue light, transmits a portion of the received blue light, and converts the other portion of the received blue light to a yellow light having a wavelength range different from that of the blue light.

The frame 113_1 includes the accommodating part 113_1a providing an accommodating space in which the light emitting diode chip 113_2 is accommodated. The accommodating part 113_1a includes a bottom surface and an inclined surface inclined with respect to the bottom surface. The frame 113_1 may further include a light reflection layer (not shown) disposed on the inclined surface of the accommodating part 113_1a.

The light emitting diode chip 113_2 is disposed on the bottom surface of the accommodating part 113_1a and emits the blue light in response to a power source. The blue light has a light emission spectrum in which a peak wavelength is in a wavelength range of about 435 nm to about 460 nm. In the present exemplary embodiment, the light emitting diode chip 113_2 includes a semiconductor chip, e.g., a compound semiconductor chip such as InGaN-based semiconductor chip, GaN-based semiconductor chip, AlGaN-based semiconductor chip.

The fluorescent layer 113_3 is disposed above the light emitting diode chip 113_2 and includes a polymer material filled in the accommodating part 113_1a to surround the light emitting diode chip 113_2. The fluorescent layer 113_3 has a chemical formula of (Ba_{1-x-y-z}SrₓCa_{y})₂SiO₄:Eu_{z} (0<x<1, 0≦y≦1, 0≦z≦1, 0≦1-x-y-z). As an example, the fluorescent layer 113_3 includes a silicate-based material (SiOₓ) containing at least one of barium (Ba), strontium (Sr), and calcium (Ca).

The fluorescent layer 113_3 is excited by the blue light provided from the light emitting diode chip 113_2 to emit the yellow light. Accordingly, the light emitting diode unit 113 may emit the white light obtained by mixing the blue light and the yellow light.

Referring to FIGS. 1 and 2 again, the light source driving part 120 outputs a driving voltage VLED to drive the light emitting diode units 112 in response to an input voltage Vin from an external source (not shown) and the control signal PWM provided from the light source controlling part 150. The driving voltage VLED controls the driving current applied to the light emitting diode units 112. For instance, the driving voltage VLED includes red, green, and blue driving voltages to respectively and independently drive the red, green, and blue light emitting diode chips 112R, 112G, and 112B included in each of the light emitting diode units 112.

The spectrum measuring part 130 includes a spectrophotometer 131 (refer to FIG. 2) to convert the light exiting from the light source part 110 to intensity according to the wavelength thereof. In particular, when the light source part 110 generates the light using the red, green, and blue light emitting diode chips 112R, 112G, and 112B, the spectrophotometer 131 measures the intensity, i.e., a spectral power distribution, by the wavelength over a wavelength range of a visible ray. As an example, the spectrophotometer 131 may be disposed at a center portion or a side surface portion of the light source part 110 in a single or plural fashion.

The optical characteristic extracting part 140 extracts optical data by an element of the light source part 110 on the basis of the spectral power distribution provided from the spectrum measuring part 130. In the case that each of the light emitting diode units 112 of the light source part 110 includes the red, green, and blue light emitting diode chips 112R, 112G, and 112B, the element of the light source part 110 may be each of the red, green, and blue light emitting diode chips 112R, 112G, and 112B.

In the case that the light source part 110 includes the light emitting diode unit 113 shown in FIG. 4, the element of the light source part 110 may be each of the light emitting diode chip 113_2 and the fluorescent layer 113_3.

FIG. 5 is a graph showing a spectral power distribution of the light emitting diode unit shown in FIG. 4.

Referring to FIG. 5, the spectral power distribution is divided into two wavelength ranges A1 and A2 as viewed relative to the peak wavelength. That is, a first spectral power distribution D1 with respect to the light emitting diode chip 113_2 (refer to FIG. 4) is positioned in the first wavelength range A1 and a second spectral power distribution D2 with respect to the fluorescent layer 113_3 is positioned in the second wavelength range A2. The first wavelength range A1 includes a first peak wavelength PW1 and the second wavelength range A2 includes a second peak wavelength PW2.

The optical characteristic extracting part 140 (refer to FIG. 1) extracts the optical data of the light emitting diode chip 113_2 on the basis of the first spectral power distribution D1 and extracts the optical data of the fluorescent layer 113_3 on the basis of the second spectral power distribution D2.

The optical data include peak areas W1 and W2 of the first and second spectral power distributions D1 and D2, an average of each of the first and second spectral power distributions D1 and D2, heights h1 and h2, i.e., intensity, of the first and second peak wavelengths PW1 and PW2, a root mean square (RMS) of each of the first and second spectral power distributions D1 and D2, a crest factor of each of the first and second spectral power distributions D1 and D2, a standard deviation of each of the first and second spectral power distributions D1 and D2, a skew of each of the first and second spectral power distributions D1 and D2, a kurtosis of each of the first and second spectral power distributions D1 and D2, full-width at half-maximum (FWHM) F1 and F2 of the first and second spectral power distributions D1 and D2, and the first and second peak wavelengths PW1 and PW2. The optical data may be used as indices to represent the optical characteristics of each element of the light source part 110.

When the elements of the light emitting diode units 112 and 113 are changed, the shape of the spectral power distribution is changed, and thus the number of the wavelength ranges distinct from each other as viewed relative to the peak wavelength.

Hereinafter, the optical characteristics of the elements, which are represented by the optical data, will be described in detail.

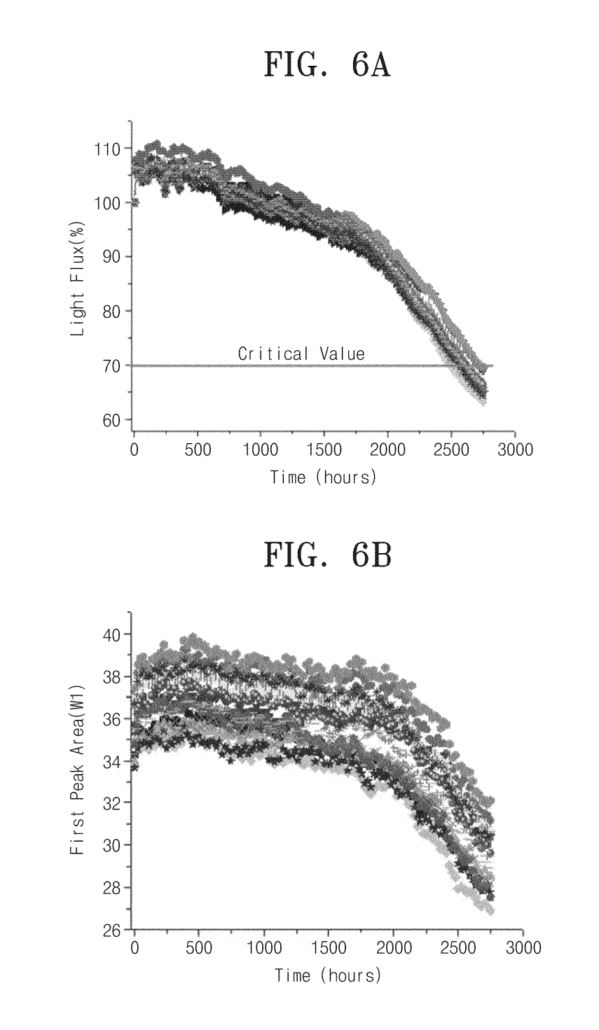

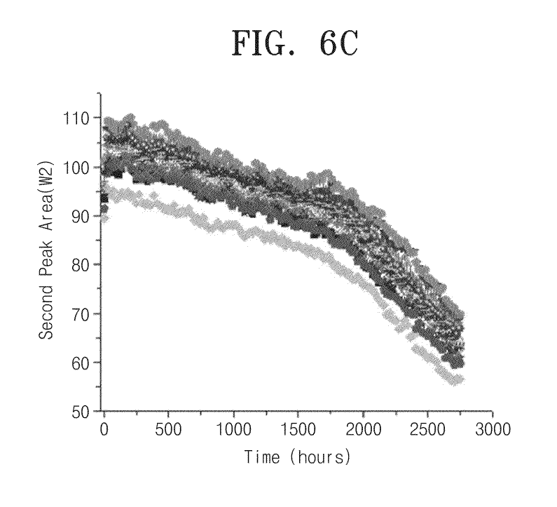

FIG. 6A is a waveform diagram showing a variation of the light flux as a function of a time of the light emitting diode unit 113, FIG. 6B is a waveform diagram showing a variation of the peak area W1 of the first spectral power distribution D1 of the light emitting diode chip 113_2 as a function of a time, and FIG. 6C is a waveform diagram showing a variation of the peak area W2 of the second spectral power distribution D2 of the fluorescent layer 113_3 as a function of a time.

Referring to FIG. 6A, the light flux of the light emitting diode unit 113 is reduced as the time elapses. When a critical value of the light flux is set to about 70% and the light emitting diode unit 113 has the light flux equal to or lower than the critical value, it means that a life span of the light emitting diode unit 113 has expired.

As shown in FIGS. 6B and 6C, the variation of the light flux with respect to the elapse of the time has a pattern similar to the peak area W1 of the first spectral power distribution D1 and the peak area W2 of the second spectral power distribution D2. That is, the peak area W1 of the first spectral power distribution D1 and the peak area W2 of the second spectral power distribution D2 are reduced as the time elapses and the reduction patterns of the peak areas W1 and W2 are similar to that of the light flux.

Accordingly, the optical characteristics about the light flux of the light emitting diode unit 113 may be checked on the basis of the peak area W1 of the first spectral power distribution D1 and the peak area W2 of the second spectral power distribution D2.

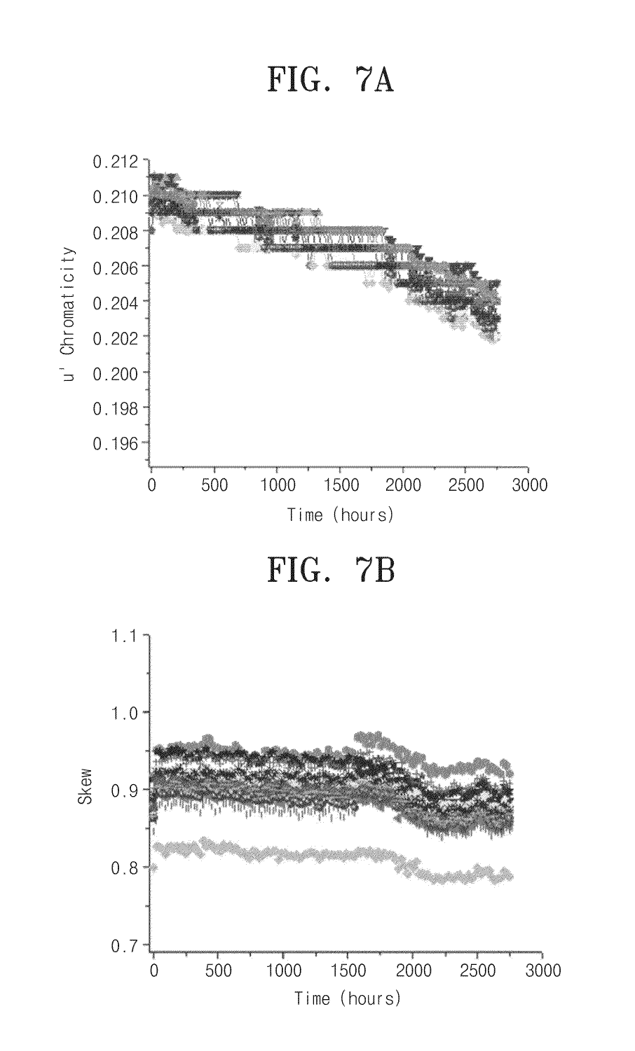

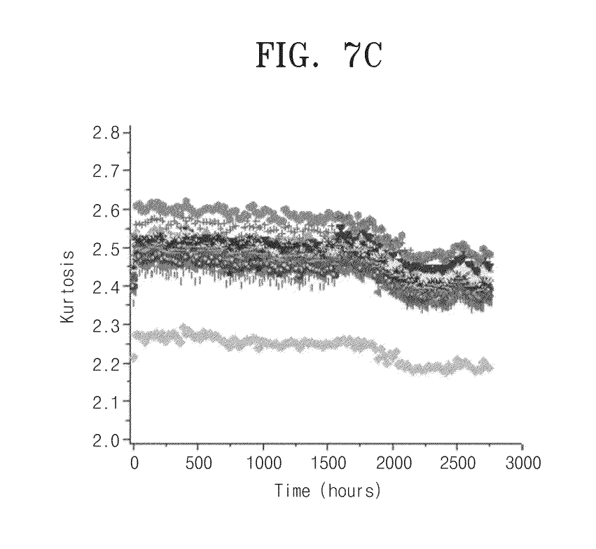

FIG. 7A is a waveform diagram showing a u′ chromaticity of the light emitting diode unit 113 as a function of a time, FIG. 7B is a waveform diagram showing the skew of the first spectral power distribution D1 of the light emitting diode chip 113_2 as a function of a time, and FIG. 7C is a waveform diagram showing the kurtosis of the first spectral power distribution of the light emitting diode chip 113_2 as a function of a time. The u′ chromaticity shown in FIG. 7A has been plotted with the 1976 CIE u′v′ color space.

Referring to FIG. 7A, the u′ chromaticity of the light emitting diode unit 113 has a pattern that is reduced as the time elapses. As shown in FIGS. 7B and 7C, the skew and the kurtosis of the first spectral power distribution D1 have a pattern that is reduced as the time elapses.

Referring to FIGS. 7A to 7C, the reduction pattern of the u′ chromaticity according to the elapse of the time is similar to that of each of the skew and the kurtosis according to the elapse of the time. Therefore, the skew or the kurtosis of the first spectral power distribution D1 generated by the optical characteristic extracting part 140 may be used to check the u′ chromaticity of the light emitting diode unit 113.

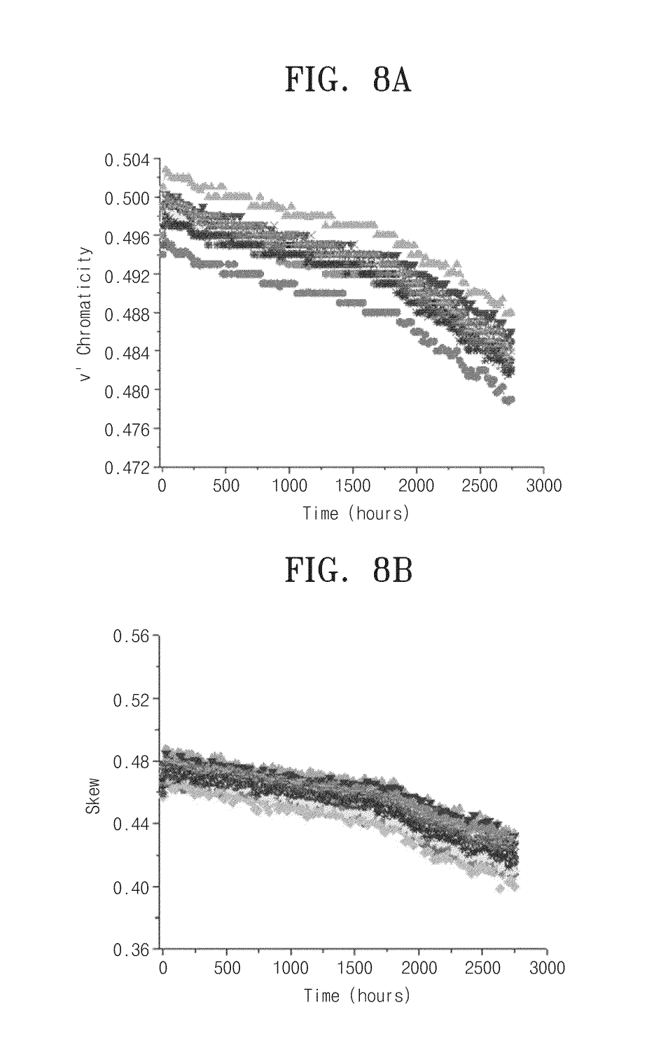

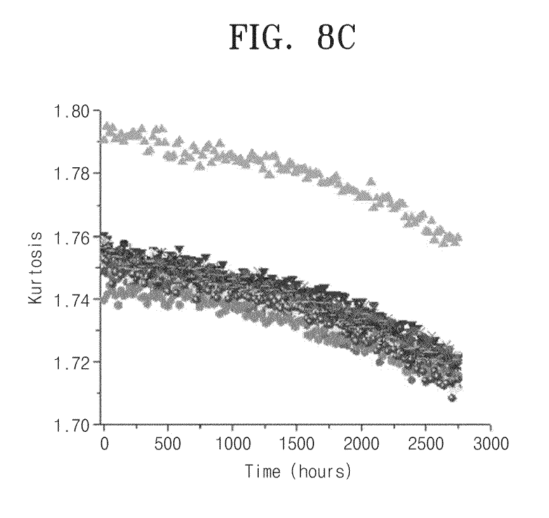

FIG. 8A is a waveform diagram showing a v′ chromaticity of a light emitting diode unit 113 as a function of a time and FIG. 8B is a waveform diagram showing a skew of a second spectral power distribution of the fluorescent layer 113_3 as a function of a time, and FIG. 8C is a waveform diagram showing a kurtosis of a second spectral power distribution of the fluorescent layer 113_3 as a function of a time. The v′ chromaticity shown in FIG. 8A has been plotted with the 1976 CIE u′v′ color space.

Referring to FIG. 8A, the v′ chromaticity of the light emitting diode unit 113 has a pattern that is reduced as the time elapses. As shown in FIGS. 8B and 8C, the skew and the kurtosis of the second spectral power distribution D2 have a pattern that is reduced as the time elapses.

Referring to FIGS. 8A to 8C, the reduction pattern of the v′ chromaticity according to the elapse of the time is similar to that of each of the skew and the kurtosis according to the elapse of the time. Therefore, the skew or the kurtosis of the second spectral power distribution D2 generated by the optical characteristic extracting part 140 may be used to check the v′ chromaticity of the light emitting diode unit 113.

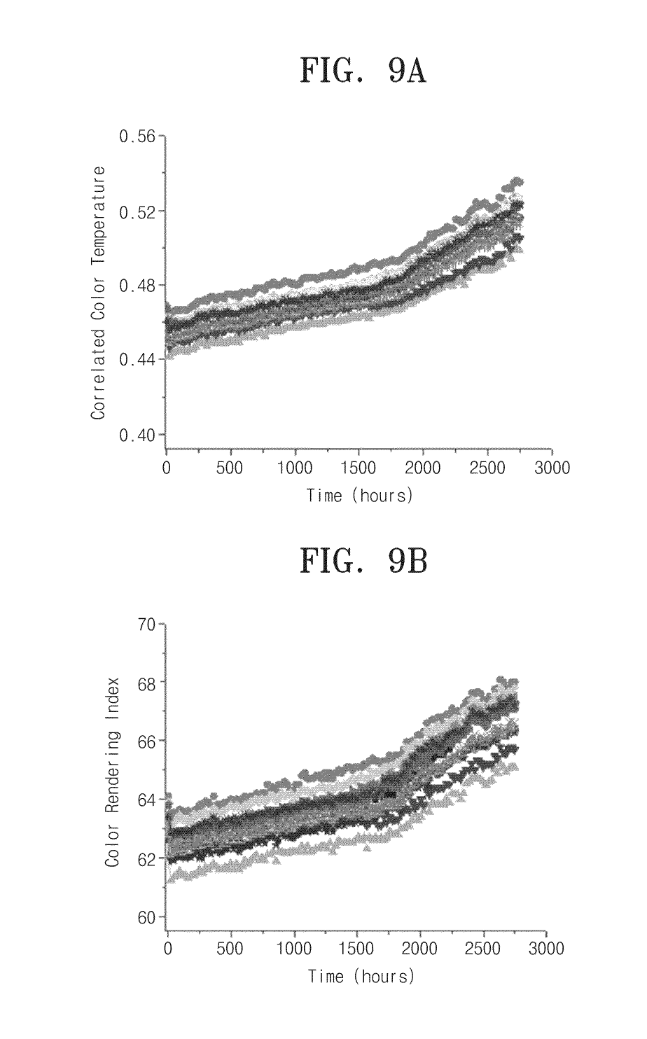

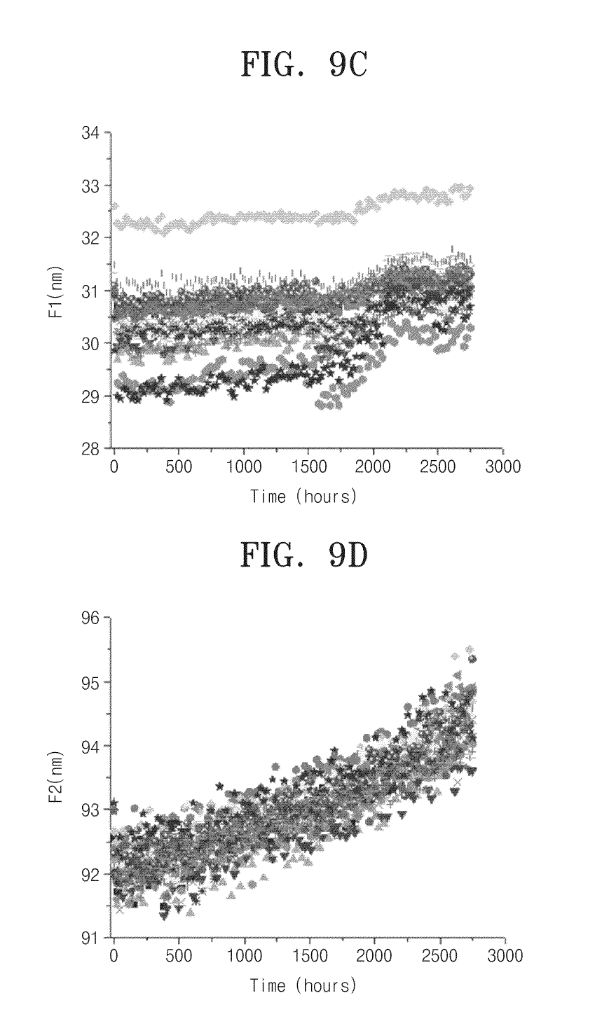

FIG. 9A is a waveform diagram showing a correlated color temperature (CCT) of the light emitting diode unit 113 as a function of a time, FIG. 9B is a waveform diagram showing a color rendering index (CRI) of the light emitting diode unit 113 as a function of a time, FIG. 9C is a waveform diagram showing the full-width at half-maximum (FWHM) of the first spectral power distribution D1 of the light emitting diode chip 113_2 as a function of a time, and FIG. 9D is a waveform diagram showing the full-width-half-maximum (FWHM) of the second spectral power distribution D2 of the fluorescent layer 113_3 as a function of a time.

Referring to FIGS. 9A and 9B, the correlated color temperature and the color rendering index of the light emitting diode unit 113 have a pattern that is increased as the time elapses. As shown in FIGS. 9C and 9D, the full-width at half-maximum of the first spectral power distribution D1 and the full-width at half-maximum of the second spectral power distribution D2 have a pattern that is increased as the time elapses.

Referring to FIGS. 9A to 9D, the increase pattern of each of the correlated color temperature and the color rendering index according to the elapse of the time is similar to the increase pattern of the full-width at half-maximum F1 and F2 according to the elapse of the time. Thus, the full-width at half-maximum F1 and F2 of the first and second spectral power distributions D1 and D2, which are generated by the optical characteristic extracting part 140, may be used to check the correlated color temperature and the color rendering index of the light emitting diode unit 113.

As described above, the optical characteristic extracting part 140 may extract various optical characteristics by each element on the basis of various optical data, e.g., root-mean-square, crest factor, standard deviation, etc., generated from the first and second spectral power distributions D1 and D2 in addition to the above-mentioned optical characteristics.

Referring to FIG. 1 again, the light source controlling part 150 extracts present optical characteristics of the light source part 110 on the basis of the various optical data generated by the optical characteristic extracting part 140 and controls the control signal PWM by each of the light emitting diode units 112 and 113 or by each element included in the light emitting diode units 112 and 113 on the basis of the extracted optical characteristics. For instance, when the light emitting diode 112 includes the red, green, and blue light emitting diode chips 112R, 112G, and 112B, the light source controlling part 150 controls a duty ratio of the control signal PWM to control the driving current applied to the red, green, and blue light emitting diode chips 112R, 112G, and 112B.

The light source driving part 120 outputs the driving voltage VLED in response to the control signal PWM to drive the light emitting diode unit 112. The voltage level of the driving voltage VLED may be varied in accordance with the duty ratio of the control signal PWM. The driving current applied to the light emitting diode unit 112 is changed in accordance with the voltage level of the driving voltage VLED. Accordingly, the brightness of the light emitting diode 112 and the optical characteristics, e.g., color coordinate, correlated color temperature, etc., of the light source part 110 may be controlled to have the target optical characteristics, e.g., target color coordinate, target correlated color temperature, etc.

Therefore, the light generating device 100 maintains the desired target optical characteristics, e.g., target color coordinate, target correlated color temperature, etc., even though the optical characteristics of the light source part 110 are changed as the time elapses, and thus the optical characteristics of the light generated by the light generating device 100 may be prevented from being degraded.

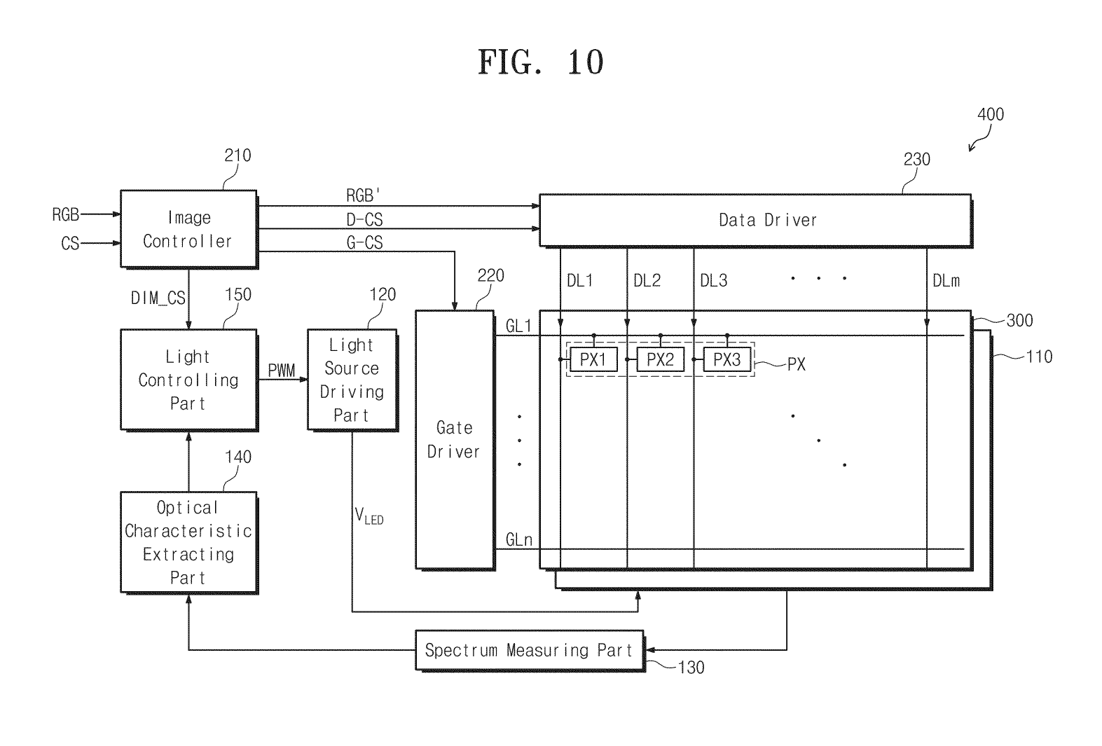

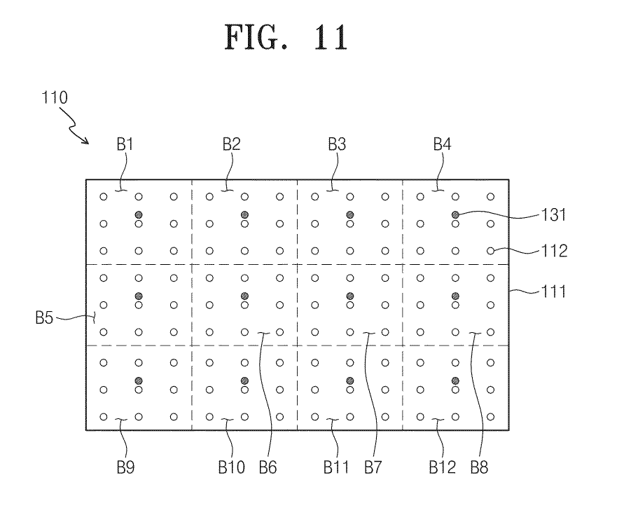

FIG. 10 is a block diagram showing a display apparatus 400 according to an exemplary embodiment of the present disclosure and FIG. 11 is a plan view showing a light source part shown in FIG. 10.

Referring to FIG. 10, the display apparatus 400 includes a display panel 300 displaying an image, panel driving parts 210, 220, and 230 driving the display panel 300, and a light generating device 100 providing a light to the display panel 100. The panel driving parts include a gate driver 220, a data driver 230, and an image controller 210 controlling the gate driver 220 and the data driver 230.

The display panel 300 includes a plurality of gate lines GL1 to GLn, a plurality of data lines DL1 to DLm, and a plurality of pixels PX. The gate lines GL1 to GLn extend in a row direction and are arranged in a column direction to be substantially parallel to each other. The data lines DL1 to DLm extend in the column direction and are arranged in the row direction to be substantially parallel to each other.

Each of the pixels PX includes first, second, and third sub-pixels PX1, PX2, and PX3 and each of the first, second, and third sub-pixels PX1, PX2, and PX3 includes a thin film transistor (not shown) and a liquid crystal capacitor (not shown). As an example, the first, second, and third sub-pixels PX1, PX2, and PX3 display red, green, and blue colors, respectively. According to another embodiment, each pixel PX may include four sub-pixels. Among the four sub-pixels, three sub-pixels respectively display the red, green, and blue colors and remaining one sub-pixel displays one of yellow, white, cyan, and magenta colors.

The image controller 210 receives RGB image signals RGB and control signals CS from an external source (not shown). The image controller 210 converts the RGB image signals RGB in consideration of an interface between the data driver 230 and the image controller 210 and applies the converted image signals RGB′ to the data driver 230. The image controller 210 generates a data control signal D-CS, e.g., an output start signal, a horizontal start signal, etc., and a gate control signal G-CS, e.g., a vertical start signal, a vertical clock signal, a vertical clock bar signal, etc., on the basis of the control signals CS. The data control signal D-CS is applied to the data driver 230 and the gate control signal G-CS is applied to the gate driver 220.

The gate driver 220 sequentially outputs gate signals in response to the gate control signal G-CS provided from the image controller 210. Accordingly, the pixels PX are sequentially scanned by the gate signals in the unit of row.

The data driver 230 converts the image signals RGB′ to data voltages in response to the data control signal D-CS provided from the image controller 210. The data voltages are applied to the display panel 300.

Therefore, each pixel PX is turned on in response to a corresponding gate signal of the gate signals and the turned-on pixel PX receives a corresponding data voltage of the data voltages from the data driver 230, thereby displaying the image corresponding to a desired grayscale level.

The light generating device shown in FIG. 10 may have the similar configuration to that of the light generating device 100 shown in FIG. 1. Thus, detailed descriptions of the elements 110, 120, 130, 140, and 150 of the light generating device are omitted in order to avoid redundancy.

The light source part 110 is disposed on a rear surface of the display panel 300 to provide the light to the display panel 300. As an example, the light source part 110 includes a plurality of light emitting diode units 112 as its light source. In this case, the light emitting diode units 112 are arranged on the circuit board 111 in a matrix form as shown in FIG. 11.

In addition, the light source part 110 is divided into a plurality of light emitting blocks B1 to B12. Each of the light emitting blocks B1 to B12 includes one or more light emitting diode units 112. The number of the light emitting blocks B1 to B12 and the number of the light emitting diode units 112 included in each of the light emitting blocks B1 to B12 should not be limited to FIG. 11.

Although not shown in figures, the display panel 300 includes a plurality of dimming areas defined therein to respectively correspond to the light emitting blocks B1 to B12.

When a local dimming method is applied, an amount of the light emitted from each of the light emitting blocks B1 to B12 may be controlled by varying the voltage level of the driving voltage VLED applied to each of the light emitting blocks B1 to B12. As a result, the display panel 300 may receive lights having different intensities according to the dimming areas. As described above, in case of the display apparatus 400 to which the local dimming method is applied, the light source controlling part 150 receives a dimming control signal DIM_CS from the image controller 210 to decide the duty ratio or the pulse width of the control signal PWM. The dimming control signal DIM_CS may be, but not limited to, a signal generated on the basis of the image signals RGB. For instance, the image controller 210 separates the image signals RGB into dimming image signals respectively corresponding to the dimming areas and calculates an average grayscale level or a maximum grayscale level of each dimming area on the basis of the dimming image signals. Accordingly, the image controller 210 generates the dimming control signal DIM_CS on the basis of the calculated average grayscale level or the calculated maximum grayscale level.

As shown in FIG. 11, the spectrum measuring part 130 includes a spectrophotometer 131 to convert the light exiting from the light source part 110 to intensity according to the wavelength thereof. In particular, when the light source part 110 is divided into the light emitting blocks B1 to B12, the spectrum measuring part 130 may include a plurality of spectrophotometers 131 respectively disposed in the light emitting blocks B1 to B12. Accordingly, the spectrophotometers 131 measure the intensity, i.e., the spectral power distribution, by the wavelength over a wavelength range of a visible ray in the light emitting blocks B1 to B12. As an example, each of the spectrophotometers 131 may be disposed at a center portion of a corresponding light emitting block of the light emitting blocks B1 to B12 in a single or plural fashion.

The light source controlling part 150 controls the duty ratio or the pulse width of the control signal PWM on the basis of the dimming control signal DIM_CS and the optical data provided from the optical characteristic extracting part 140 and applies the control signal PWM to the light source driving part 120.

Therefore, the light source driving part 120 varies the voltage level of the driving voltage VLED applied to each of the light emitting blocks B1 to B12 to realize the local dimming. In addition, the light source driving part 120 measures the optical characteristics by the light emitting blocks B1 to B12 and reflects the measured optical characteristics in the driving voltage VLED in real time to allow the optical characteristics of each of the light emitting blocks B1 to B12 to have the target optical characteristics, e.g., the target color coordinate, the target correlated color temperature, etc.

Thus, the display apparatus 400 may prevent a display quality of the image displayed through the display apparatus 400 from being degraded due to the variation of the optical characteristics of the light source part 110 according to the hours of use.

In addition, although there are various types of structure of the light source part 110 applied to the display apparatus 400 and there are various types of elements used in the light source part 110, the optical characteristics provided by the elements included in the light source part 110 may be extracted by using the spectrophotometer 131. Accordingly, the light source part 110 is driven in accordance with the optical characteristics of the elements, and thus the light emitted from the light source part 110 may be precisely controlled to have the target optical characteristics.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A light generating device comprising:
a light source driving part generating a driving voltage in response to a control signal;
a light source part generating a light in response to the driving voltage;
a measuring part receiving the light generated by the light source part to measure a spectral power distribution of the light;
an extracting part measuring optical data provided by elements of the light source part on the basis of the spectral power distribution and extracting optical characteristics provided by the elements on the basis of the optical data; and
a light source controlling part controlling the control signal on the basis of the optical characteristics.

2. The light generating device of claim 1, wherein the measuring part comprises a spectrophotometer disposed in the light source part to measure the spectral power distribution of the light.

3. The light generating device of claim 1, wherein the light source part comprises a plurality of light emitting diode units each comprising light emitting diode chips respectively displaying first, second, and third colors.

4. The light generating device of claim 3, wherein at least one of the first, second, and third colors comprises one of red, green, and blue color.

5. The light generating device of claim 1, wherein the light source part comprises a plurality of light emitting diode units each comprising a light emitting diode chip displaying a first color and a fluorescent layer displaying a fourth color different from the first color.

6. The light generating device of claim 1, wherein the spectral power distribution comprises at least two spectral power distributions and the optical characteristics by the elements of the light source part are extracted on the basis of the optical data caused by each of the spectral power distributions.

7. The light generating device of claim 6, wherein the optical data comprises one of;
an area of a peak area,
a peak wavelength,
an intensity of the peak wavelength,
a standard deviation,
a kurtosis,
a skew, and
a full-width at half-maximum with respect to each of the spectral power distributions.

8. A display apparatus comprising:
a light source driving part generating a driving voltage in response to a control signal;
a light source part generating a light in response to the driving voltage;
a display panel receiving the light to display an image;
a measuring part receiving the light from the light source part to measure a spectral power distribution of the light;
an extracting part measuring optical data by elements of the light source part on the basis of the spectral power distribution and extracting optical characteristics by the elements on the basis of the optical data; and
a light source controlling part controlling the control signal on the basis of the optical characteristics.

9. The display apparatus of claim 8, wherein the measuring part comprises a spectrophotometer disposed in the light source part to measure the spectral power distribution of the light.

10. The display apparatus of claim 8, wherein the light source part comprises a plurality of light emitting diode units each comprising light emitting diode chips respectively displaying first, second, and third colors.

11. The display apparatus of claim 10, wherein at least one of the first, second, and third colors comprises one of red, green, and blue color.

12. The display apparatus of claim 8, wherein the light source part comprises a plurality of light emitting diode units each comprising a light emitting diode chip displaying a first color and a fluorescent layer displaying a fourth color different from the first color.

13. The display apparatus of claim 8, further comprising a panel driving part to drive the display panel, wherein the panel driving part comprises:
an image controller generating an image signal, a gate control signal, and a data control signal;
a gate driver applying a gate signal to the display panel in response to the gate control signal; and
a data driver applying a data signal to the display panel in response to the data control signal.

14. The display apparatus of claim 13, wherein the light source part comprises a plurality of light emitting blocks each comprising one or more light emitting diode units.

15. The display apparatus of claim 14, wherein the measuring part comprises a plurality of spectrophotometers respectively corresponding to the light emitting blocks.

16. The display apparatus of claim 8, wherein the spectral power distribution comprises at least two spectral power distributions and the optical characteristics by the elements of the light source part are extracted on the basis of the optical data caused by each of the spectral power distributions.

17. The display apparatus of claim 16, wherein the optical data comprises one of
an area of a peak area,
a peak wavelength,
an intensity of the peak wavelength,
a standard deviation,
a kurtosis,
a skew, and
a full-width at half-maximum with respect to each of the spectral power distributions.

18. A light generating device comprising:
a light source driving part receiving a control signal and generating a driving voltage in response to the control signal;
a light source part generating a light in response to the driving voltage;
a measuring part receiving the light generated by the light source part and measuring a spectral power distribution of the light;
an extracting part measuring optical data outputted by elements of the light source part on the basis of the spectral power distribution and extracting optical characteristics including color coordinate and correlated color temperature provided by the elements on the basis of the measured optical data; and
a light source controlling part controlling the control signal on the basis of the extracted optical characteristics,
the measuring part comprises an array of spectrophotometers disposed in the light source part to measure the spectral power distribution of the light.

19. The light generating device of claim 18, wherein the light source part generates a white light by mixing a yellow and a blue light.
